(19) United States
(12) Patent Application Publication
(10) Pub. No.: US 2012/0173712 A1
(43) Pub. Date: Jul. 5, 2012

(54) METHOD AND DEVICE FOR IDENTIFYING P2P APPLICATION CONNECTIONS

(75) Inventor: Cheng MA, Shenzhen (CN)

(73) Assignee: Sangfor Networks Company Limited

(21) Appl. No.: 13/170,190

(22) Filed: Jun. 28, 2011

(30) Foreign Application Priority Data
Jan. 4, 2011 (CN) 201110000484.6

(51) Int. Cl. G06F 15/16

(52) U.S. Cl. 709/224

(57) ABSTRACT

The present invention relates to a method for identifying P2P application connections, which includes: searching corresponding ports of intranet IPs according to the data package received; and identifying the connection of the data package to be P2P application connection when the counter value of the said port is the preset threshold and represents the number of all simultaneous online UDP connections to the port. When the counter value of the said port is not the preset threshold, and the connection of the data package is a new UDP connection, the counter value of the said port will be added by 1; when the UDP connection of the said port is disconnected, the counter value of the port will be deducted by 1. It is a primary object of the present invention to provide a method and a device for identifying P2P application connections based on the behavioral characteristics of UDP, which have improved the accuracy of P2P application identification.

### FIELD OF THE INVENTION

The present invention relates to the communications field, particularly to a method and a device for identifying P2P application connections.

### BACKGROUND OF THE INVENTION

According to the statistics of some authoritative organizations, the current P2P traffic on the Internet accounts for 49% to 83% of the total traffic, or even exceeds 95% in deep night. Therefore, the P2P applications consume much bandwidth, and shall be managed and controlled. The critical premise of controlling P2P applications is the identification of P2P applications in the interne traffic. At present, the P2P uplink traffic detection method is generally adopted to identify P2P applications by utilizing the traffic characteristic statistics of P2P applications' uplink with the same port and source address. One shortcoming of the method is that it can only identify the uplink but not the downlink. In addition, the uplink traffic detecting method only applies to UDP connections but not to TCP connections. If single TCP connections require long time to be connected and packages sended, a misjudgment will surely be caused. Further analysis shows that the P2P uplink traffic detecting method is unscientific itself, and any application connected and packages sended for long time will be misjudged as a P2P application.

### SUMMARY OF THE INVENTION

It is a primary object of the present invention to provide a method and a device for identifying P2P application connections based on the behavioral characteristics of UDP, which have improved the accuracy of P2P application identification.

The present invention provides a method for identifying P2P application connections, including:

Searching the corresponding port of the intranet IP according to data package received;

Identifying the connection of the data package to be P2P application connection when the counter value of the port is the preset threshold and are also the same number as UDP connections that are simultaneously online;

Adding 1 to the counter value of the port, when the counter value of the port is not the preset value and the connection of the data package is a new UDP connection;

Deducting 1 from the counter value of the port, when the UDP connection of the port is disconnected.

Preferably, before searching the corresponding port of the intranet IP based on the data package received, including:

The counter of the port and the corresponding preset threshold of the counter are set.

Preferably, after searching the corresponding port of the intranet IP according to the data package received, including:

The counter value of the said port is acquired;

Whether the counter value is actually the preset threshold.

Preferably, the searching of the corresponding port of the intranet IP according to the data package received includes:

Receiving data packages;

Extracting the corresponding intranet IP and port according to the data package.

Preferably, the extracting of the corresponding intranet IP and port according to the data package includes:

Extracting corresponding nodes, such as the multiple elements set including the intranet IP, port and counter, from the preset node list through the Hash algorithm.

The present invention also provides a device for identifying P2P application connections, including:

A searching module for searching the corresponding port of the intranet IP according to data package received;

An identifying module for identifying the connection of the data package as a P2P application connection when the counter value of the port is the preset threshold and those counter value and port represent the number of all simultaneously online UDP connections;

A number-adding module for adding 1 to the counter value of the port when the counter value of the port is not the preset value and the connection of the data package is a new UDP connection;

A number-deducting module for deducting 1 from the counter value of the port, when the UDP connection of the port is disconnected.

Preferably, the device for identifying P2P application connections further comprises:

A setting module for setting the counter of the port and the corresponding preset threshold of the counter.

Preferably, the device for identifying P2P application connections further comprises:

An acquiring module for acquiring the counter value of the port;

A judging module for judging whether or not the counter value is the preset threshold.

Preferably, the searching module includes:

A receiving unit for receiving data packages;

An extracting unit for extracting the corresponding intranet IP and port according to the data packages.

Preferably, the extracting unit is specifically applied to:

Extracting corresponding nodes, such as the multiple elements set including the intranet IP, port and counter, from the preset node list through the Hash algorithm.

A method and a device provided by the present invention for identifying P2P application connections. That is, to identify P2P application connections based on whether the number of UDP connections established simultaneously at the same port of the same intranet IP reaches the preset threshold, and improve the accuracy of identifying P2P applications.

### DESCRIPTION OF THE FIGURES

FIG. 1 shows the architecture of the current P2P application scene;

FIG. 2 shows a flow diagram of an embodiment of the method used to identify P2P application connections in the present invention;

FIG. 3 shows a flow diagram of an embodiment of port searching of the method used to identify P2P application connections in the present invention;

FIG. 4 shows a flow diagram of another embodiment of the method used to identify P2P application connections in the present invention;

FIG. 5 shows a flow diagram of an embodiment of the device used to identify P2P application connections in the present invention;

FIG. 6 shows a flow diagram of another embodiment of the device used to identify P2P application connections in the present invention.

The realization, functional characteristics and advantages of the object of the invention are to be described with embodiments and further described with the attached figures.

### DETAILED DESCRIPTION OF THE INVENTION

A method and a device provided by the present invention for identifying P2P application connections. That is, to identify P2P application connections based on whether the number of UDP connections established and those simultaneously established at the same port of the same intranet IP reaches the preset threshold.

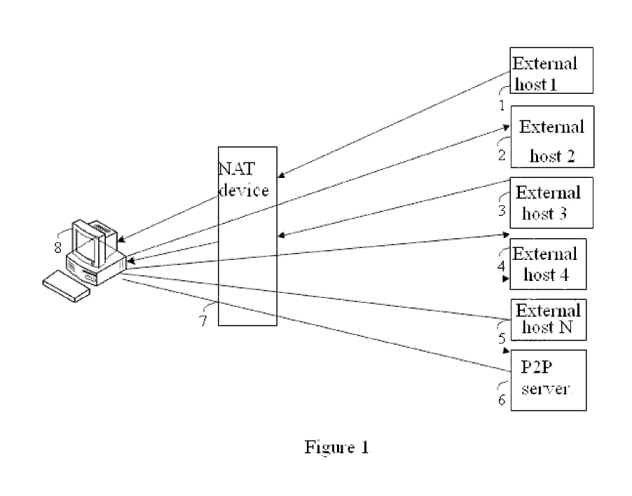

With reference to FIG. 1, the behavioral features of UDP in P2P applications are described as follows:

The P2P server 6 has a detailed record of resource distribution situations and port access situations in the wide area network after a series of interactions with each of the p2p clients. It is presumed that some intranet server 8 (192.168.1.5: 8001) requires resource m, and only resource n can be provided. The P2P server 6 then notifies, through the exchange process with some intranet host 8, to the port accesses of its external hosts 22 (96.30.230.6: 2222), 44 (205.47.66.3: 4444) and N5 (202.137.6.1: 4321), to have the resource m available for download. At this time, the intranet host 8 has the following UDP connections established: [192.168.1.5: 8001<->96.30.230.6: 2222], [192.168.1.5: 8001<->205.47.66.3: 4444] and [192.168.1.5: 8001<->202.137.6.1: 4321].

The P2P server notifies, through communications with the p2p clients of the external hosts 11 (222.23.88.1, 1111) and 33 (202.35.60.5: 3333), to port accesses of external hosts 11 and 33, and NAT device 7 (202.101.5.91: 6001) to have the resource n available for download. At this time, the external hosts 11 and 33 initiate connections to the NAT device. After the address is converted by the NAT device, the UDP connections finally established are [222.23.88.1, 1111<->192.168.1.5: 8001], [202.35.60.5: 3333<->192.168.1.5: 8001].

It can be seen that in P2P applications, the intranet host 8 requires to have simultaneous UDP connections with multiple external network hosts for resource exchange. When the number of UDP connections of any port, such as 8001, of the intranet host 8 reaches a certain figure, it can be considered that the subsequent UDP connections that transmit data packages with the port are P2P application connections.

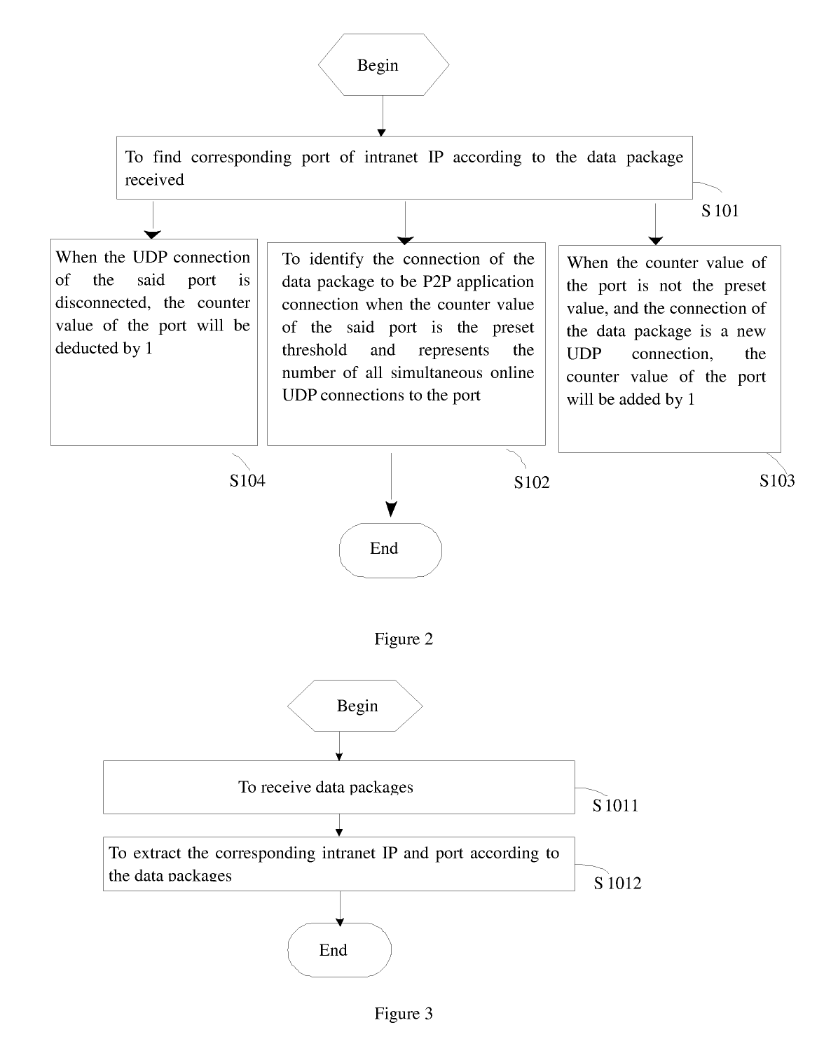

With reference to FIG. 2, an embodiment of the method in the present invention used to identify P2P application connections is provided, including:

Step S101, to search the corresponding port of the intranet IP according to data packages received;

The user first sets a device for identifying P2P application connections, which can be connected to the devices such as gateway, Network Bridge and/or fire walls etc., or built within the aforementioned devices.

To search the port of the intranet IP that corresponds to a data package, when the device for identifying P2P application connections receives the data package.

Step S102, to identify the connection of the data package to be P2P application connection when the counter value of the said port is the preset threshold and those counter value represents the number of all simultaneous online UDP connections to the same port;

The intranet often includes many IPs, and each IP has many ports. Each port has a corresponding counter, which is preset to count the number of UDP connections to the corresponding port. Take FIG. 1 as an example, when the receiver or sender of a data package is the intranet host 8 (192.168.1.5: 8001), the counter value of port 8001 of the intranet host 8 will be determined. When the counter value is the preset threshold, the connection of the data package is identified as a P2P application connection. The preset threshold can be set based on experience.

Step S103, to add 1 to the counter value of the port, when the counter value of the port is not the preset value and the connection of the data package is a new UDP connection;

When the counter value of port 8001 of the intranet host 8 is not the preset threshold, the connection of the data package cannot be determined as a P2P application connection, and then, the connection of the data package is a new UDP connection or an existing UDP connection is to be determined. If it is a new UDP connection, 1 is added to the counter value of the port 8001. To judge whether the connection of the data package is a new UDP connection or an existing UDP connection, the following methods can be adopted. When an external network host connects to the port 8001 for the first time, the counter identification of the connection is set to 1; and if it is disconnected, the counter identification is changed to 0.

Step S104, to deduct 1 from the counter value of the port when the UDP connection of the port is disconnected.

When some existing UDP connection of port 8001 of the intranet host 8 is disconnected, the counter value of port 8001 is deducted by 1.

Note that the present invention can eliminate one or more IP or port as required, not to monitor the P2P applications of the above IP or port.

A method for identifying P2P application connections provided by the present invention identifies the P2P application connections based on whether the number of UDP connections established simultaneously at the same port of the same intranet IP reaches the preset threshold, and improves the accuracy of identifying P2P applications.

With reference to FIG. 3, in an embodiment of the method in the present invention for identifying the P2P application connection, Step S101 includes:

Step S1011, to receive data packages;

Step S1012, to extract the corresponding intranet IP and port according to the said data package.

Step S1012 may include:

To extract corresponding nodes, such as the multiple elements set including the intranet IP, port and counter, from the preset node list through the Hash algorithm.

For the device used to identify P2P application connections, a node list can be preset, in which each node is a multiple element set. A typical embodiment is the triple element set (IP, port and counter). When a data package is received, the corresponding intranet IP and port are extracted. The intranet IP and the port are taken as the parameter, and corresponding nodes are found in the node list through Hash algorithm. Then the corresponding counter of the port of the intranet IP is acquired.

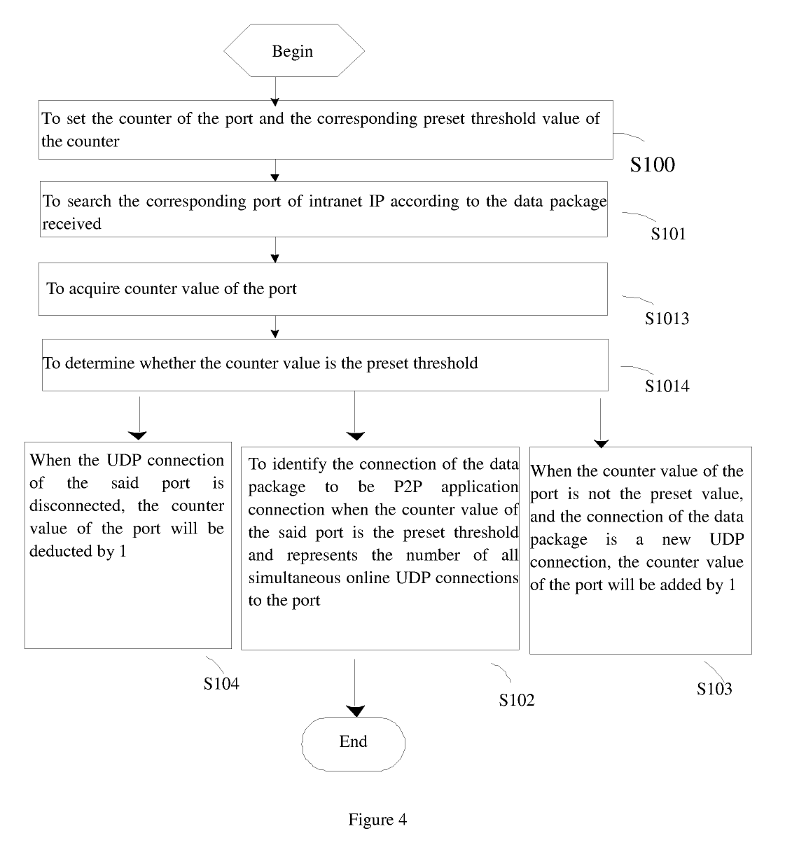

With reference to FIG. 4, another embodiment of the method in the present invention used to identify P2P application connections is provided. The foregoing embodiment, before Step S101, includes:

Step S100, the counter of the said port and the corresponding preset threshold of the counter are set.

The counter of a specified port of the intranet IP is set; the counter is used to count simultaneous online UDP connections of the port. The corresponding preset threshold of the counter based on practical experience is set. When the number of simultaneous online UDP connections reaches the preset threshold, it can be considered that the subsequent UDP connections that transmit data packages with the port are P2P application connections.

After Step S101, including:

Step S1013, to acquire the counter value of the port;

Step S1014, to determine whether the counter value is the preset threshold.

Based on the previous embodiment, the present embodiment sets the counter and preset threshold of the port as required, and determines the counter value after receiving the data packages. This enhances the flexibility based on the previous embodiment.

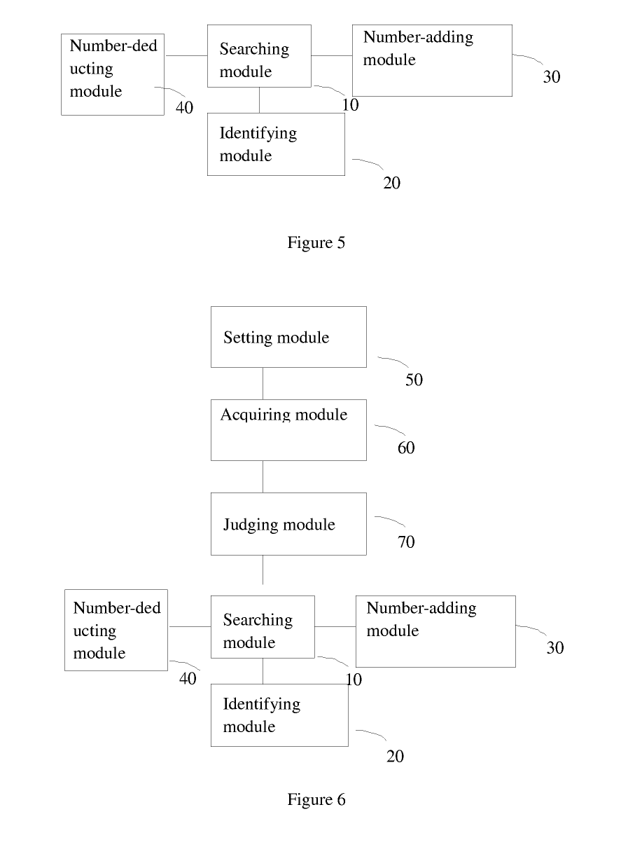

With reference to FIG. 5, an embodiment of the device in the present invention used to identify P2P application connections is provided, including:

A searching module 10, used to search the corresponding port of the intranet IP according to the data package received;

An identifying module 20, used to identify the connection of the data package to be P2P application connection when the counter value of the said port is the preset threshold and represents the number of all simultaneous online UDP connections to the port;

A number-adding module 30, used to add 1 to the counter number of the said port when the counter value of the port is not the preset value, and the connection of the data package is a new UDP connection;

A number-deducting module 40, used to deduct 1 from the counter value of the port, when the UDP connection of the said port is disconnected.

The device for identifying P2P application connections can be connected to devices such as gateway, Network Bridge and/or fire walls and the like, or built into the foregoing devices.

When the device for identifying P2P application connections receive a data package, the searching module 10 will find the port of the intranet IP corresponding to the data package.

The intranet often includes many IPs, and each IP often has many ports. Each port has a corresponding counter, which is preset to count the number of UDP connections to the corresponding port. Take FIG. 1 as an example, when the receiver or sender of a data package is the intranet host 8 (192.168.1.5: 8001), the counter value of port 8001 of the intranet host 8 will be determined. When the counter value is the preset threshold, the identifying module 20 will identify the connection of the data package as a P2P application connection. The preset threshold can be set based on experience.

When the counter value of port 8001 of the intranet host 8 is not the preset threshold, the connection of the data package cannot be determined as a P2P application connection, and then the connection of the data package is a new UDP connection or an existing UDP connection is to be determined. If it is a new UDP connection, the number-adding module 30 notifies the counter of port 8001 to add 1. To judge whether the connection of the data package is a new UDP connection or an existing UDP connection, the following methods can be adopted. When an external network host connects with the port 8001 for the first time, the counter identification of the connection is set to 1; and if it is disconnected, the counter identification is changed to 0.

When some existing UDP connection of port 8001 of the intranet host 8 is disconnected, the number-deducting module 40 notifies the counter of the port 8001 to deduct 1.

Note that the present invention can eliminate one or more IP or port as required, not to monitor the P2P applications of the above IP or port. A device for identifying P2P application connections provided by the present invention identifies the P2P application connections according to whether the number of UDP connections established simultaneously at the same port of the same intranet IP reaches the preset threshold, and improves the accuracy of identifying P2P applications.

In the embodiment of the device in the present invention used to identify the P2P application connection, the searching module 10 can include:

A receiving unit 11, used to receive data packages;

An extracting unit 12, used to extract the corresponding intranet IP and port according to the data packages.

The extracting unit 12 is specifically used for:

Extracting corresponding nodes, such as the multiple element set including the intranet IP, port and counter, in the preset node list with Hash algorithm. For the device used to identify P2P application connections, a node list can be preset, in which each node is a multiple element set. A typical embodiment is the triple element set (IP, port and counter). When the receiving unit 11 receives a data package, the extracting unit 12 extracts the corresponding intranet IP and port. The intranet IP and the port are taken as the parameter, and corresponding nodes are found in the node list through Hash algorithm. Then the corresponding counter of the port of intranet IP is acquired.

With reference to FIG. 6, another embodiment of the device in the present invention used to identify P2P application connections is provided. The embodiment of the device for identifying P2P application connections also includes:

A setting module 50, used to set the counter of the said port and the corresponding preset threshold of the counter;

An acquiring module 60, used to acquire the counter value of the port;

A judging module 70, used to judge whether the counter value is the preset threshold or not.

The setting module 50 sets the counter of a specified port of the intranet IP; the counter is used to count simultaneous online UDP connections of the port. The corresponding preset threshold of the counter is set based on practical experience. When the number of simultaneous online UDP connections reaches the preset threshold, it can be considered that the subsequent UDP connections that transmit data packages with the port are P2P application connections.

Based on the previous embodiment, the present embodiment sets the counter and preset threshold set of the port as required, and determines the counter value after receiving the data packages. This enhances the flexibility based on the previous embodiment.

The abovementioned are embodiments preferably selected for the present invention, but constitutes to no limit on the patent scope of the present invention. Any equivalent structure or flow transformation of the description and figures hereof of the invention, or other related technical field directly or indirectly applied are also included in the patent scope of the invention to be protected as the same reason.

What is claimed is:

1. A method for identifying P2P application connections comprising:
searching corresponding ports of intranet IPs according to the data package received;
identifying the connection of the data package to be P2P application connection when the counter value of the port is the preset threshold and represents the number of all simultaneous online UDP connections to the port;
adding 1 to the counter value of the port, when the counter value of the port is not the preset threshold, and the connection of the data package is a new UDP connection; and
deducting 1 from the counter value of the port, when the UDP connection of the port is disconnected.

2. A method for identifying P2P application according claim 1, wherein before the searching of the corresponding port of the intranet IP according to the data package received, the counter of the port and the corresponding preset threshold of the counter are set.

3. A method for identifying P2P application according to claim 1, wherein after the searching of the corresponding port of the intranet IP according to the data package received, the counter value of the port is acquired; and whether the counter value is the preset threshold can be determined.

4. A method for identifying P2P application according to claim 2, wherein after the searching of the corresponding port of the intranet IP according to the data package received, the counter value of the port is acquired; and whether the counter value is the preset threshold can be determined.

5. A method for identifying P2P application according to claim 1, wherein the step of searching the corresponding port of the intranet IP according to the data package received, comprising:
receiving the data package; and
extracting the corresponding intranet IP and port according to the said data package.

6. A method for identifying P2P application according to claim 2, wherein the step of searching the corresponding port of the intranet IP according to the data package received including:
receiving the data package; and
extracting the corresponding intranet IP and port according to the data package.

7. A method for identifying P2P application according to claim 5, wherein the step of extracting the corresponding intranet IP and port according to the data package includes:
extracting corresponding nodes, such as the multiple elements set including the intranet IP, port and counter, from the preset node list through the Hash algorithm.

8. A method for identifying P2P application according to claim 6, wherein the step of extracting the corresponding intranet IP and port according to the data package includes:
extracting corresponding nodes, such as the multiple elements set including the intranet IP, port and counter, from the preset node list through the Hash algorithm.

9. A device for identifying P2P application connections, comprising:
a searching module, used to search the corresponding port of the intranet IP according to the data package received;
an identifying module, used to identify the connection of the data package as a P2P application connection when the counter value of the port is the preset threshold and represents the number of all simultaneous online UDP connections to the port;
a number-adding module, used to add 1 to the counter number of the port when the counter value of the port is not the preset value, and the connection of the data package is a new UDP connection; and
a number-deducting module, used to deduct 1 from the counter value of the port, when the UDP connection of the port is disconnected.

10. A device for identifying P2P application according to claim 9, further comprising:
a setting module, used to set the counter of the port and the corresponding preset threshold of the counter.

11. A device for identifying P2P application according to claim 9, further comprising:
an acquiring module for acquiring the counter value of the port;
a judging module for judging whether the counter value is the preset threshold or not.

12. A device for identifying P2P application according to claim 10, further comprising:
an acquiring module for acquiring the counter value of the port;
a judging module for judging whether the counter value is the preset threshold or not.

13. A device for identifying P2P application according to claim 9, wherein the searching module comprises:
a receiving unit for receiving the data package;
an extracting unit for extracting the corresponding intranet IP and port according to the said data package.

14. A device for identifying P2P application according to claim 10, wherein the searching module comprises:
a receiving unit for receiving the data package;
an extracting unit for extracting the corresponding intranet IP and port according to the said data package.

15. A device for identifying P2P application according to claim 13, wherein the extracting unit is applied to:
extracting corresponding nodes, such as the multiple elements set including the intranet IP, port and counter, from the preset node list through the Hash algorithm.

16. A device for identifying P2P application according to claim 14, wherein the extracting unit is applied to:
extracting corresponding nodes, such as the multiple elements set including the intranet IP, port and counter, from the preset node list through the Hash algorithm.
